(19) United States
(12) Patent Application Publication
(10) Pub. No.: US 2018/0155982 A1
(43) Pub. Date: Jun. 7, 2018

(54) Cord Retraction System

(71) Applicant: Sushma Medikayala, Fayetteville, NC (US)

(72) Inventor: Sushma Medikayala, Fayetteville, NC (US)

(21) Appl. No.: 15/367,781

(22) Filed: Dec. 2, 2016

(51) Int. Cl. E06B 9/326

(52) U.S. Cl. CPC E06B 9/326

(57) ABSTRACT

A cord retraction system includes a window treatment that may be positioned in a window thereby facilitating the window treatment to selectively cover the window. A cord is coupled to the window treatment. The cord selectively urges the window treatment between a deployed position and a retracted position. A retraction unit is coupled to the cord and the retraction unit may be manipulated. The retraction unit selectively stores the cord to inhibit the cord from being accessible to children.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to retraction devices and more particularly pertains to a new retraction device for inhibiting a window treatment cord from being accessible to children.

### BRIEF SUMMARY OF THE INVENTION

An embodiment of the disclosure meets the needs presented above by generally comprising a window treatment that may be positioned in a window thereby facilitating the window treatment to selectively cover the window. A cord is coupled to the window treatment. The cord selectively urges the window treatment between a deployed position and a retracted position. A retraction unit is coupled to the cord and the retraction unit may be manipulated. The retraction unit selectively stores the cord to inhibit the cord from being accessible to children.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a cord retraction system according to an embodiment of the disclosure.

FIG. 2 is a bottom view of a retraction unit of an embodiment of the disclosure.

FIG. 3 is a front view of a retraction unit of an embodiment of the disclosure.

FIG. 4 is a cross sectional view taken along line 4-4 of FIG. 3 of an embodiment of the disclosure.

FIG. 5 is a cross sectional view taken along line 5-5 of FIG. 4 of an embodiment of the disclosure.

### DETAILED DESCRIPTION OF THE INVENTION

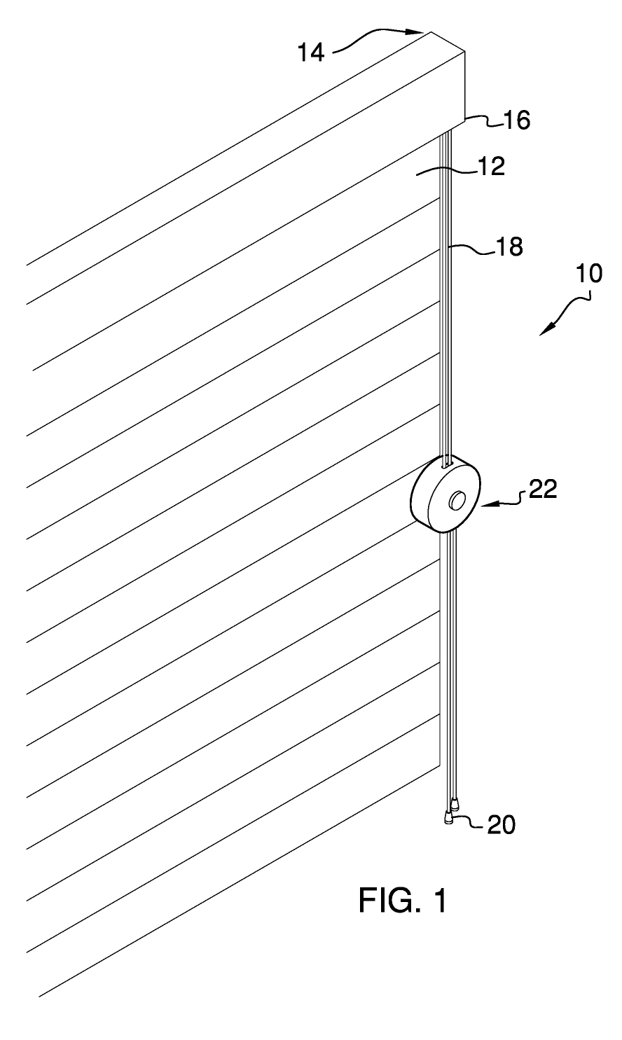

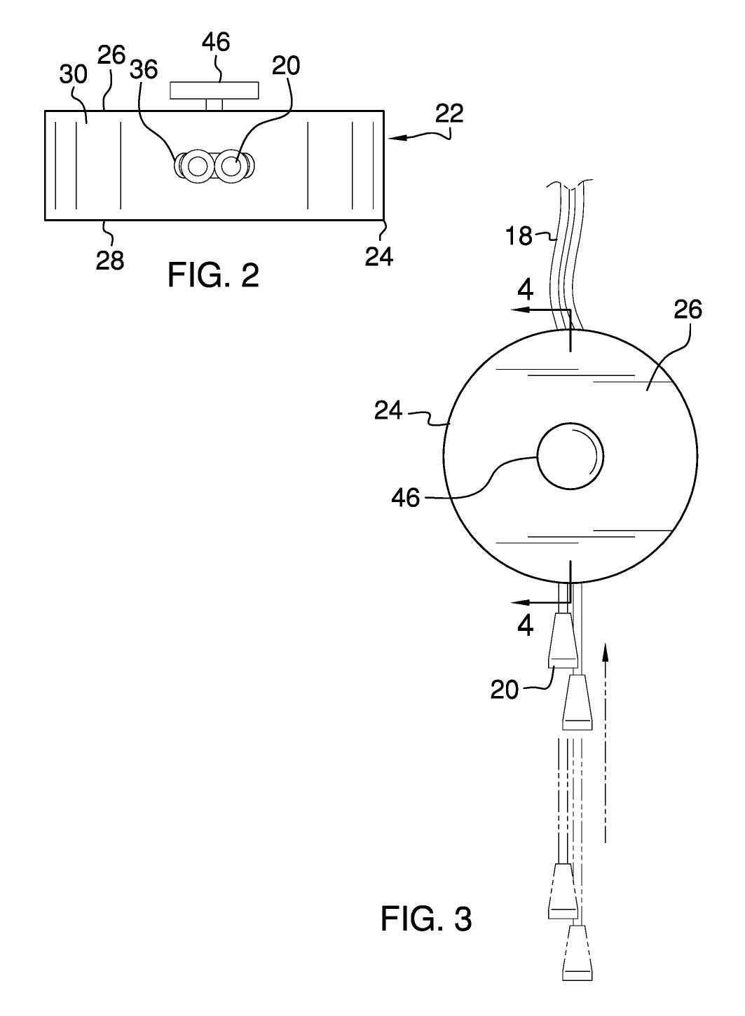

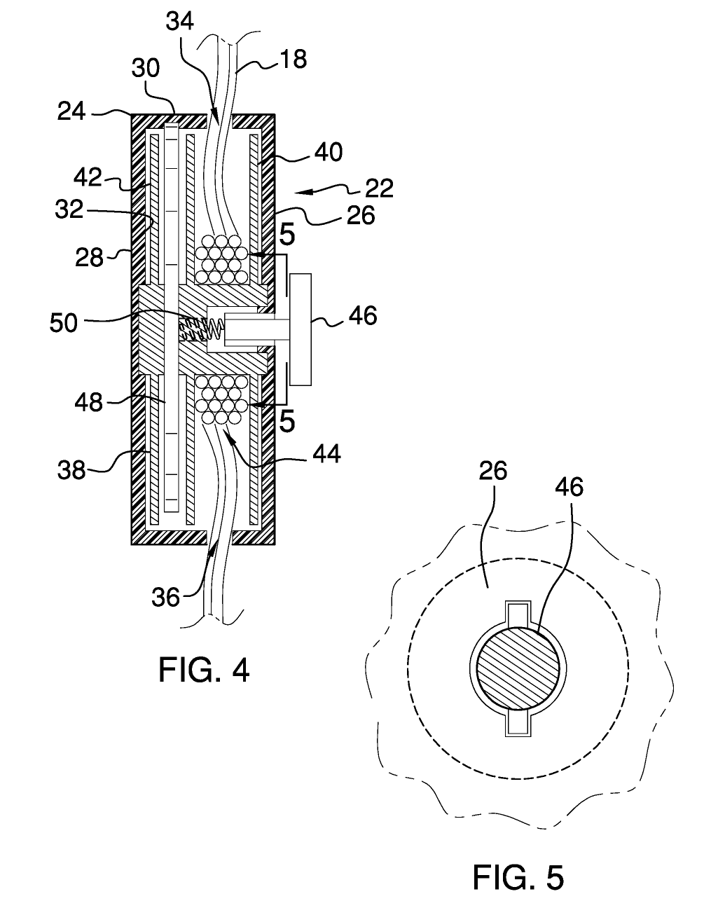

With reference now to the drawings, and in particular to FIGS. 1 through 5 thereof, a new retraction device embodying the principles and concepts of an embodiment of the disclosure and generally designated by the reference numeral 10 will be described.

As best illustrated in FIGS. 1 through 5, the cord retraction system 10 generally comprises a window treatment 12 that is positioned in a window 14 thereby facilitating the window treatment 12 to selectively cover the window 14. The window treatment 12 has an upper threshold 16 and the window 14 may be window 14 in a building or the like. The window treatment 12 may be blinds, curtains, drapes or any other selectively deployable window treatment 12.

A cord 18 is coupled to the window treatment 12 and the cord 18 may be manipulated. The cord 18 selectively urges the window treatment 12 between a deployed position and a retracted position. The cord 18 has a distal end 20 with respect to the window treatment 12. A retraction unit 22 is coupled to the cord 18 and the retraction unit 22 may be manipulated. The retraction unit 22 selectively stores the cord 18 to inhibit the cord 18 from being accessible to children.

The retraction unit 22 comprises a housing 24 that has a front wall 26, a back wall 28 and a perimeter wall 30 extending therebetween. The housing 24 has an inner surface 32 and the housing 24 is substantially hollow. The perimeter wall 30 has a first aperture 34 extending into an interior of the housing 24 and the perimeter wall 30 has a second aperture 36 extending into the interior of the housing 24. The first aperture 34 is aligned with the second aperture 36. The cord 18 extends through each of the first aperture 34 and the second aperture 36 having the housing 24 being spaced from the distal end 20 of the cord 18.

A spool 38 is provided and the spool 38 is rotatably positioned within the housing 24. The spool 38 is selectively rotated in a first direction and a second direction. The spool 38 has a first side 40 that is spaced from a second side 42 to define a cord space 44 between the first side 40 and the second side 42. The second side 42 is rotatably coupled to the inner surface 32 corresponding to the back wall 28. Moreover, the spool 38 is slidable along an axis extending through the first side 40 and the second side 42. The second side 42 engages the inner surface 32 corresponding to the front wall 26 such that the spool 38 is inhibited from rotating. The spool 38 may engage the front wall 26 with complementary tabs and grooves, a mechanical locking mechanism or any other means of inhibiting the spool 38 from rotating.

A button 46 is movably coupled to the front wall 26 of the housing 24 and the button 46 may be manipulated. The button 46 urges the first side 40 of the spool 38 to disengage the front wall 26 of the housing 24. In this way the spool 38 is selectively rotatable in the first direction and the second direction.

A first biasing member 48 is positioned around the spool 38. The first biasing member 48 is coupled to the inner surface 32 of the housing 24 such that the biasing member biases the spool 38 to rotate in the first direction. The first biasing member 48 may be a coil spring or the like. The cord 18 is wrapped around the spool 38 when the spool 38 is rotated in the first direction. Moreover, the cord 18 is positioned in the cord space 44 when the cord 18 is wrapped around the spool 38.

The cord 18 is drawn into each of the first aperture 34 and the second aperture 36. In this way the housing 24 is positioned adjacent to the upper threshold 16 of the window treatment 12 when the spool 38 is rotated in the first direction. The distal end 20 of the cord 18 abuts the housing 24 when the spool 38 is rotated in the first direction. In this way the cord 18 is positioned out of the children's reach. The distal end 20 of the cord 18 is gripped and the distal end 20 is urged away from the housing 24 to selectively rotate the spool 38 in the second direction. In this way the cord 18 is unwrapped from the spool 38 when the spool 38 is rotated in the second direction.

A second biasing member 50 is provided and the second biasing member 50 is coupled between the spool 38 and the button 46. The second biasing member 50 biases the button 46 away from the spool 38 such that the spool 38 engages the front wall 26 of the housing 24. The second biasing member 50 may be a spring or the like.

In use, the button 46 is depressed to facilitate the spool 38 to rotate. The distal end 20 of the cord 18 is gripped and the cord 18 is manipulated to position the window treatment 12 between the deployed position and the retracted position. The distal end 20 of the cord 18 is released and the spool 38 is biased to rotate in the first direction. Thus, the cord 18 is stored in the housing 24 and the housing 24 is positioned adjacent to the top threshold of the window treatment 12. In this way the retraction unit 22 inhibits the children from manipulating the cord 18 and potentially damaging the window treatment 12. Additionally, the retraction unit 22 stores the cord 18 to inhibit the cord 18 from posing a strangling hazard to the children.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A cord retraction system comprising:
a window treatment being configured to be positioned in a window thereby facilitating said window treatment to selectively cover the window;
a cord being coupled to said window treatment wherein said cord is configured to be manipulated, said cord selectively urging said window treatment between a deployed position and a retracted position, said cord having a distal end relative to said window treatment; and
a retraction unit being coupled to said cord wherein said retraction unit is configured to be manipulated, said retraction unit selectively storing said cord wherein said retraction unit is configured to inhibit said cord from being accessible to children, said retraction unit including a housing having a front wall, a back wall and a perimeter wall extending therebetween, said housing being substantially hollow, said perimeter wall having a first aperture extending into an interior of said housing, said perimeter wall having a second aperture extending into said interior of said housing, said first aperture being aligned with said second aperture, said cord extending through each of said first aperture and said second aperture having said housing being spaced from said distal end of said cord, said housing having an inner surface.

2. (canceled)

3. (canceled)

4. (canceled)

5. The system according to claim 1, further comprising a spool being rotatably positioned within said housing, said being selectively rotated in a first direction and a second direction, said spool having a first side being spaced from a second side to define a cord space between said first side and said second side, said second side being rotatably coupled to said inner surface corresponding to said back wall, said spool being slidable along an axis extending through said first side and said second side, said second side engaging said inner surface corresponding to said front wall such that said spool is inhibited from rotating.

6. The system according to claim 5, further comprising a button being movably coupled to said front wall of said housing wherein said button is configured to be manipulated, said button urging said first side of said spool to disengage said front wall of said housing such that said spool is selectively rotatable in said first direction and said second direction.

7. The system according to claim 5, further comprising a first biasing member being positioned around said spool, said first biasing member being coupled to said inner surface of said housing such that said biasing member biases said spool to rotate in said first direction, said cord wrapped around said spool when said spool is rotated in said first direction having said housing being positioned adjacent to said upper threshold of said window treatment, said distal end of said cord abutting said housing when said spool is rotated in said first direction wherein said cord is configured to be out of the children's reach, said cord being unwrapped from said spool when said spool is rotated in said second direction.

8. The system according to claim 6, further comprising a second biasing member being coupled between said spool and said button, said second biasing member biasing said button away from said spool such that said spool engages said front wall of said housing.

9. A cord retraction system comprising:
a window treatment being configured to be positioned in a window thereby facilitating said window treatment to selectively cover the window, said window treatment having an upper threshold;
a cord being coupled to said window treatment wherein said cord is configured to be manipulated, said cord selectively urging said window treatment between a deployed position and a retracted position, said cord having a distal end with respect to said window treatment; and
a retraction unit being coupled to said cord wherein said retraction unit is configured to be manipulated, said retraction unit selectively storing said cord wherein said retraction unit is configured to inhibit said cord from being accessible to children, said retraction unit comprising:
a housing having a front wall, a back wall and a perimeter wall extending therebetween, said housing being substantially hollow, said perimeter wall having a first aperture extending into an interior of said housing, said perimeter wall having a second aperture extending into said interior of said housing, said first aperture being aligned with said second aperture, said cord extending through each of said first aperture and said second aperture having said housing being spaced from said distal end of said cord, said housing having an inner surface,
a spool being rotatably positioned within said housing, said being selectively rotated in a first direction and a second direction, said spool having a first side being spaced from a second side to define a cord space between said first side and said second side, said second side being rotatably coupled to said inner surface corresponding to said back wall, said spool being slidable along an axis extending through said first side and said second side, said second side engaging said inner surface corresponding to said front wall such that said spool is inhibited from rotating,
a button being movably coupled to said front wall of said housing wherein said button is configured to be manipulated, said button urging said first side of said spool to disengage said front wall of said housing such that said spool is selectively rotatable in said first direction and said second direction,
a first biasing member being positioned around said spool, said first biasing member being coupled to said inner surface of said housing such that said biasing member biases said spool to rotate in said first direction, said cord being wrapped around said spool when said spool is rotated in said first direction having said housing being positioned adjacent to said upper threshold of said window treatment, said distal end of said cord abutting said housing when said spool is rotated in said first direction wherein said cord is configured to be out of the children's reach, said cord being unwrapped from said spool when said spool is rotated in said second direction, and
a second biasing member being coupled between said spool and said button, said second biasing member biasing said button away from said spool such that said spool engages said front wall of said housing.
